(19) United States
(12) Patent Application Publication
(10) Pub. No.: US 2006/0195261 A1
(43) Pub. Date: Aug. 31, 2006

(54) Electronic device for tracking and monitoring assets

(75) Inventor: Joshua Ian Riley, Arden, NC (US)

Correspondence Address: BRACEWELL & GIULIANI LLP, P.O. BOX 61389, HOUSTON, TX, 77208-1389, US

(73) Assignee: Homeland Integrated Security Systems, Inc., Asheville, NC (US)

(21) Appl. No.: 11/350,435

(22) Filed: Feb. 9, 2006

Related U.S. Application Data
(63) Continuation-in-part of application No. 10/906,248, filed on Feb. 10, 2005, now abandoned.

(51) Int. Cl. G01C 21/26

(52) U.S. Cl. 701/213; 701/207

(57) ABSTRACT

Embodiments of the present invention provide for an electronic device for tracking assets. In one embodiment, the device comprises a single board computer adapted to communicate with a network, the computer comprising a location component and a communication component. In another embodiment the device comprises a computer having over-the-air programming functionality, the computer comprising a location component and a communication component. Embodiments of the present invention also provide for a system for tracking assets comprising a network and a single board computer in communication with the network, the computer comprising a location component and a communication component. Embodiments of the present invention further provide for a system of stack charging an electronic device in a plurality of orientations. Embodiments of the present invention additionally provide for a method of securing a facility comprising the steps of issuing a tracking device to an asset by automated kiosk upon arrival at the facility, linking the tracking device to the asset, and monitoring the asset with the tracking device.

### RELATED APPLICATION

This application is a continuation-in-part of U.S. patent application Ser. No. 10/906,248, filed on Feb. 10, 2005.

### BACKGROUND OF THE INVENTION

1. Field of the Invention

This invention relates generally to location devices and, more specifically, to an electronic device for tracking and monitoring assets.

2. Description of Related Art

Rapid advancement has occurred in recent years in the fields of location and tracking. Most of the location systems now in use rely on triangulation to determine location. The global positioning system (GPS) is currently the most used system for determining location. A GPS receiver with a clear view of the sky can quickly and accurately determine location anywhere in the world. The long range navigation (LORAN) system is based on radio transmissions and, therefore, a LORAN receiver does not require a clear view of the sky; however, LORAN has a limited range and requires numerous land-based transmitting stations to function effectively. LORAN is most often used for marine navigation near shore.

Some tracking devices, such as the LOJACK® from LoJack Corporation, rely on a radio transmitter and a directional receiver to determine the approximate distance and direction from the receiver to the transmitter; however, devices such as LOJACK® operate over a relatively short distance and are ill-suited for tracking the location of a moving object. Dead reckoning is sometimes used when other systems of determining location are not available; however, dead reckoning tends to be inaccurate and is generally not used if other methods of determining location are available.

Some devices have melded GPS with cellular network data transmission to create navigational and tracking devices. These devices are often built into vehicles. An example is the ONSTAR® system from General Motors Corporation available on some vehicles. These systems, however, cannot be moved from vehicle to vehicle and are not easily programmed for different applications. Other devices use GPS in conjunction with satellite data transmission. An example is OUTERLINK® from Outerlink Corporation. These systems' reliance on expensive satellite data transmission has limited their popularity. These systems also cannot be easily moved or programmed for different applications.

Prior art devices and systems have proven ill-suited to the tracking and monitoring needs of security officials and consumers. For example, port security has emerged as a significant issue due to the vulnerability of ports to attack. This vulnerability stems from ports' size, easy accessibility by water and land, and the tremendous amount of cargo handled. It has become apparent that the maritime transportation system could be used by terrorists to smuggle personnel, weapons of mass destruction, or other dangerous materials into the United States. Ships in United States ports also could be attacked by terrorists. A large-scale terrorist attack on a United States port could paralyze global maritime commerce in addition to causing local death and damage.

The increased use of cargo containers in maritime commerce presents a particularly significant security concern. The contents of only a very few containers are physically inspected. Furthermore, the movement of containers throughout ports is poorly monitored. Thus the current situation provides malfeasants with a simple method of importing contraband or attacking targets within a port. It is therefore crucial to efforts to increase maritime security that, in addition to increased inspections, the movement of traffic at ports is monitored.

### SUMMARY OF THE INVENTION

The need for a more flexible and functional tracking and monitoring device has become clear, particularly in the wake of the terrorist attacks of Sep. 11, 2001. Until the present invention, however, no device has provided the flexibility and functionality needed by security officials and consumers.

The great flexibility and functionality of the present invention permits it to adapt to a myriad of situations. The flexibility and functionality stems from a combination of features not found in the prior art. The features described below are not intended as an exhaustive list, and those of skill in the art will recognize that less than all of the features described distinguish the present invention from the prior art.

The present invention's single board design permits greater flexibility than prior art devices by reducing the size of the device to a degree previously unattainable while simultaneously providing greater functionality than much larger devices. The compact size is achieved by placing most of the components of the device on a single circuit board. A computer with many of the capabilities of a personal computer is thus attained with much smaller size. In a preferred embodiment, the size of the device including its enclosure is approximately five inches square by one inch thick.

Use of a widely-supported operating system permits embodiments of the device to communicate with many other devices and networks. A preferred embodiment uses an open source operating system software having networking functionality such as LINUX®. LINUX® is available from numerous vendors and supports most networking protocols and application platform software. A preferred embodiment uses an application platform software providing a runtime environment such as JAVA® from Sun Microsystems, Inc. Use of LINUX® and JAVA® permits the development of custom-tailored application software in a small fraction of the time development of such software would require using machine language.

Advanced networking capabilities permit embodiments of the device to transfer data wirelessly and receive over-the-air programming. Wireless data transfer provides for real-time monitoring of any parameter capable of electronic measurement. For example, the location, speed, and direction of travel of an asset can be transferred wirelessly in real time. In another example, voice data can be transferred at the push of a button. It is also possible in some embodiments to transfer voice data and other data simultaneously. Over-the-air programming provides for the ability to reprogram and control embodiments of the device remotely.

Recordation of the identity of a particular device preferably can be facilitated through the use of a built in radio frequency identification (RFID) tag. The device also preferably may be stack charged in a plurality of orientations, thus permitting automated dispensing, recovery, and charging. A stack charging feature preferably is facilitated by a plurality of nodes on the device that are arranged so that any pair of nodes will provide power to the device as long as one node receives voltage of positive polarity and a different node receives voltage of negative polarity.

A method of securing a facility is also described. In a preferred method, a tracking device is issued to an asset by an automated kiosk upon arrival at a facility. Information identifying the tracking device and the asset are recorded and associated. Finally, the asset is monitored using the tracking device. The automated kiosk, which preferably also is a charger, can preferably read an RFID tag inside the tracking device and therefore identify the tracking device upon issuance. A network preferably also is provided through which information can be transferred.

### BRIEF DESCRIPTION OF THE DRAWINGS

Some of the features and benefits of the present invention having been stated, others will become apparent as the description proceeds when taken in conjunction with the accompanying drawings, in which:

FIG. 1 is a block diagram of an electronic tracking and monitoring device according to the present invention.

FIG. 2 is an exploded view of an electronic tracking and monitoring device according to the present invention.

FIG. 3 is a perspective view of the exterior of an electronic tracking and monitoring device according to the present invention.

FIG. 4 is a block diagram of an electronic tracking and monitoring device according to the present invention.

FIG. 5 is an exploded view of an electronic tracking and monitoring device according to the present invention.

FIG. 6. is a perspective view of the exterior of an electronic tracking and monitoring device according to the present invention.

FIG. 7 is a diagram of a system for tracking and monitoring assets according to the present invention.

FIG. 8 is a flow chart of a method of securing a facility according to the present invention.

### DETAILED DESCRIPTION

The present invention now will be described more fully hereinafter with reference to the accompanying drawings in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

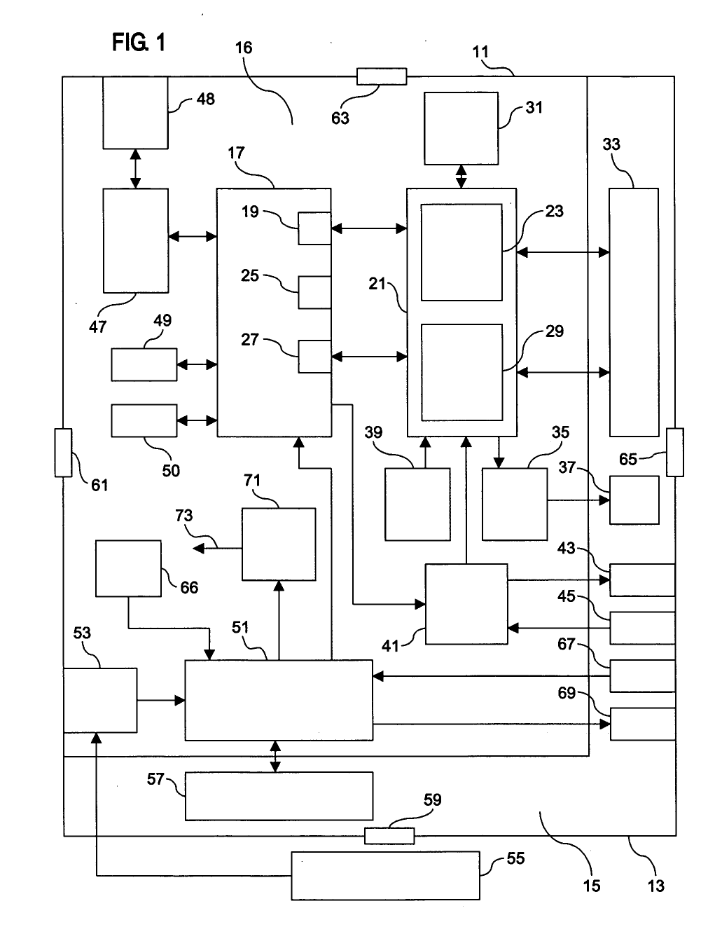

FIG. 1 is a block diagram of an electronic tracking and monitoring device according to the present invention. The tracking device includes single board computer 11, enclosure 13, and space 15 between single board computer 11 and enclosure 13. Single board computer 11 includes circuit board 16 upon which many of the components of the tracking device are mounted. Although a single board computer is preferred for reasons including size and cost, those of skill in the art will recognize that embodiments of the device could be constructed by other, less preferable, methods. In a preferred embodiment, circuit board 16 is an eight-layer impedance controlled printed circuit board manufactured from FR4 material with components mounted on both sides. Processor 17 is mounted on circuit board 16. In a preferred embodiment, a model PXA255 reduced instruction set computer (RISC) processor, available from Intel Corporation, is used; however, those of skill in the art will recognize that many processors are operable with the invention.

Processor 17 includes communications port one 19 (COM1). COM1 communicates with module 21, and in particular with communication component 23, which is part of module 21. In a preferred embodiment, module 21 is a model iO200 integrated wireless modem, available from Motorola Inc., and communication component 23 is a wireless modem that operates in integrated digital enhanced network (iDEN® from Motorola Inc.) 800 MHz and 900 MHz networks using iDEN® packet switched and circuit switched data protocols. Those of skill in the art will recognize that communication component 23 could comprise a wide variety of wireless communication means including, for example, any of a variety of cellular modems, a Wi-Fi card, a WiMAX card, or a satellite modem. Communication component 23 communicates with a wireless network using a transmission protocol. In a preferred embodiment, transmission control protocol with Internet protocol (TCP/IP) is used, and the device is preferably assigned an IP address. Alternatively, user datagram protocol (UDP) or other protocols could be used. In a preferred embodiment, communication component 23 supports push-to-talk functionality. This feature allows bilateral verbal communication between a user of the device, such as a truck driver, and monitoring personnel at the push of a button.

Processor 17 also includes communications port two 25 (COM2), which is not in use; however, COM2 could be used during development by connecting a pin-header. Such an arrangement would provide a software console port suitable for downloading a new operating system image and/or application software. Processor 17 also includes communications port three 27 (COM3). COM3 communicates with module 21, and in particular with location component 29, which is part of module 21. In a preferred embodiment, location component 29 is a global positioning system (GPS) receiver. Those of skill in the art will recognize that location component 29 could comprise a wide variety of location means including, for example, a LORAN receiver or dead reckoning device. Location component 29 preferably provides real time location data. That data is transferred via communication component 23 to a network. In a preferred embodiment, communication component 23 multiplexes push-to-talk and data transfer. Thus, in a preferred embodiment, real time location or other data can be transferred simultaneously with verbal communication.

In a preferred embodiment, module 21, and in particular communication component 23, communicates with a subscriber identity module (SIM) socket 31. Module 21 preferably also communicates with antenna 33. Antenna 33 is located in space 15 and functions as the antenna for both communication component 23 and location component 29. In a preferred embodiment, antenna 33 is a triple band embedded antenna covering 806-870 MHz, 896-941 MHz, and 1573-1577 MHz. In an alternate embodiment, antenna 33 could be located external to enclosure 13. Module 21 further communicates with amplifier 35, which in turn powers speaker 37. Module 21 additionally communicates with microphone 39.

Processor 17 communicates with digital input/output expander integrated circuit 41 (digital I/O expander IC). Digital I/O expander IC 41 in turn communicates with module 21, communication status LEDs 43, and push-to-talk button 45. In a preferred embodiment, processor 17 communicates with digital I/O expander IC 41 via an inter-integrated circuit bus. Alternatively, processor 17 could communicate directly with module 21, communication status LEDs 43, and push-to-talk button 45 without digital I/O expander IC 41 (not shown). In either preferred embodiment, digital I/O is used to control power sequencing to module 21. Processor 17 also communicates with Ethernet controller 47, which in turn communicates with Ethernet connection 48. In a preferred embodiment, Ethernet controller 47 provides a single 10BaseT interface and Ethernet connection 48 consists of an RJ45 connection compatible with a standard Ethernet adaptor cable. Ethernet compatibility permits the device to interoperate with a wide variety of devices. For instance, the device may be connected to a computer for operation using a wired connection. Additionally, the device may be connected to any sort of sensor or system providing an electronic signal. For example, the device could receive engine temperature data from a temperature sensor and provide real time temperature data. If the temperature exceeded a range of acceptable temperatures, the device could signal monitoring personnel. Those of skill in the art will understand that other wired electronic connections such as FireWire® from Apple Computer Inc. and USB, as well as short range wireless connections such as IrDA® from Infrared Data Association Corporation and Bluetooth® from Bluetooth SIG, Inc., are within the scope of the invention and can be used to connect with many sensors and systems providing an electronic signal.

Processor 17 further communicates with nonvolatile memory 49. In a preferred embodiment, nonvolatile memory 49 comprises a 16 MB flash memory. Nonvolatile memory 49 preferably stores boot software, open source operating system software having networking functionality, and application platform software providing a runtime environment. In a preferred embodiment, the boot software consists of REDBOOT®, available from Red Hat, Inc., to boot embedded LINUX®, the operating system consists of embedded LINUX®, and the application platform consists of IBM® J2ME JAVA® run-time environment and application software available from International Business Machines Corporation. The LINUX® operating system is preferred because it is open source, supports networking functions such as TCP/IP and UDP, and supports JAVA®. Those of skill in the art will recognize that the type of nonvolatile memory and stored software disclosed are only examples, and that many types of nonvolatile memory-and software are operable with the invention. Single board computer 11 preferably includes over-the-air programming functionality. Thus, with this feature, software can be uploaded or updated remotely while the device is in use. This feature preferably permits new software to be transferred over a network and loaded into nonvolatile memory 49.

Processor 17 also communicates with system memory 50. In a preferred embodiment, system memory 50 comprises a 32 MB synchronous dynamic random access memory (SDRAM).

Single board computer 11 also includes power source management circuits 51. Circuits 51 may receive power from power connector 53. Power connector 53 is preferably adapted to accept power from vehicle battery 55 or an external 12V DC supply via a power jack. Power connector 53 preferably includes power conditioning circuits that provide transient voltage protection and constant 12V power to power source management circuits 51. Circuits 51 also may receive power from battery 57. In a preferred embodiment, battery 57 is a rechargeable 4.8V nickel metal hydride (NiMH) battery pack comprising four AA size 1.8 Ah cylindrical cells located within space 15. Those of skill in the art will recognize that many types, sizes, and capacities of batteries are operable with the invention, such as lithium ion batteries. Circuits 51 also may receive power from nodes 59, 61, 63, and 65 via diode bridge 66. The nodes preferably receive 12V power when the device is placed inside a charger. The charger includes contacts adapted to be positioned adjacent to the nodes in a plurality of orientations, such as right-side-up, up-side-down, side-ways, and backward. In a preferred embodiment, any opposite pair of nodes can provide power to the device, without regard to the polarity of the voltage applied, as long as one node receives voltage of positive polarity and the other node receives voltage of negative polarity. For example, node 59 could receive voltage of positive polarity and node 63 could receive voltage of negative polarity, or node 59 could receive voltage of negative polarity and node 63 could receive voltage of positive polarity. Power from the nodes passes through diode bridge 66, which ensures the correct polarity, and from there feeds into power source management circuits 51.

Power source management circuits 51 control power source selection, battery 57 charging, and device on/off status. When receiving power from a power jack or vehicle battery 55, circuits 51 preferably use that power source to power the device and charge battery 57. Circuits 51 preferably stop charging battery 57 if circuits 51 detect that that battery 57 is fully charged. When receiving power from nodes 59, 61, 63, and 65, circuits 51 preferably signal processor 17 to cut power to module 21. Circuits 51 preferably charge battery 57 until fully charged while receiving power from the nodes. When power to the nodes is removed processor 17 preferably boots up. Power to module 21 is preferably restored when the device is signaled to do so by the charger. When receiving power from battery 57, circuits 51 preferably monitor battery 57 for sufficient power. In the preferred embodiment, circuits 51 signal processor 17 if the voltage provided by battery 57 drops below a predetermined level. Circuits 51 preferably cut-off battery 57 if the voltage provided by battery 57 drops below a lower predetermined voltage such that over-discharge of battery 57 is prevented.

Power source management circuits 51 communicate with on/off buttons 67. On/off buttons 67 preferably may be remotely disabled using software in order to prevent a user from turning off the device. Circuits 51 also communicate with power status LEDs 69. Circuits 51 further communicate with power supply units 71. In a preferred embodiment, power supply units 71 provide power 73 to single board computer 11, including a 1.0V supply to processor 17 and a 3.3V supply to the rest of single board computer 11, including module 21.

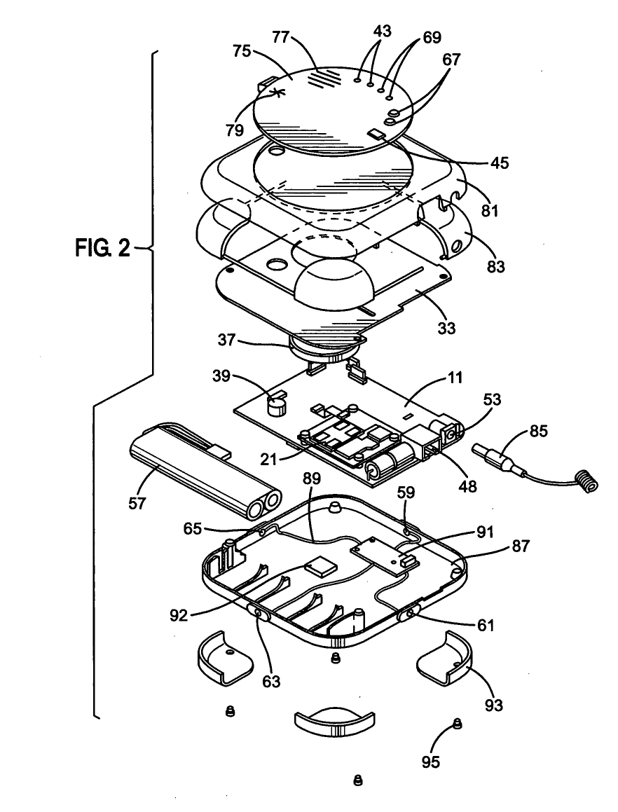

FIG. 2 is an exploded view of an electronic tracking and monitoring device according to the present invention. Membrane 75 includes speaker grill 77, microphone grill 79, communication status LEDs 43, push-to-talk button 45, on/off buttons 67, and power status LEDs 69. Membrane 75 is mounted on enclosure top 81. Enclosure top 81 is preferably molded from either polypropylene or polycarbonate plastic. Rubber buffers 83 are mounted on the corners of enclosure top 81. Antenna 33 is mounted below enclosure top 81 but above single board computer 11 in order to maximize signal strength. Single board computer 11 includes module 21, microphone 39, Ethernet connector 48, and power connector 53. Speaker 65 is mounted between single board computer 11 and enclosure top 81. Power connector 53 is adapted to accept power jack 85.

Enclosure base 87 is preferably molded from either polypropylene or polycarbonate plastic. Enclosure base 87 supports battery 57 and single board computer 11. Nodes 59, 61, 63 and 65 are mounted on the sides of enclosure base 87. The nodes are connected by wires 89 to node base 91, which in turn is connected to single board computer 11. RFID tag 92 is preferably mounted on enclosure base 87 to permit identification of the device, and is readable from at least the underside of the device when assembled. Base buffers 93 are mounted on the corners of enclosure base 87. Screw-hole plugs 95 are preferably fitted to base 87 after assembly of the device.

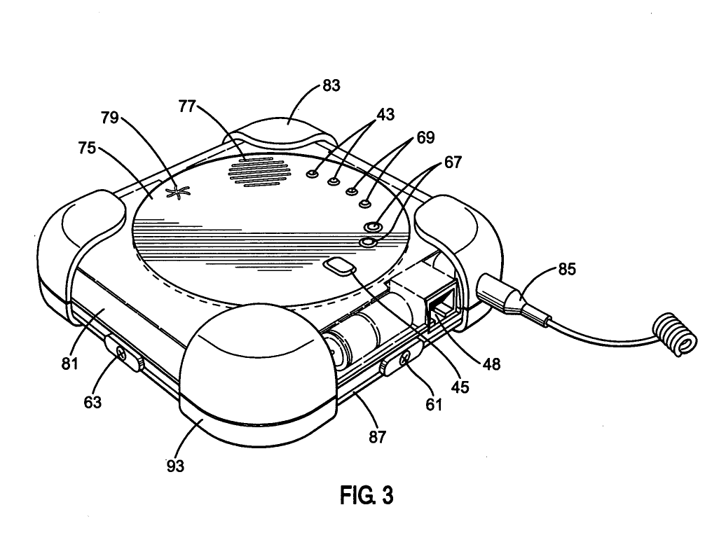

FIG. 3 is a perspective view of the exterior of an electronic tracking and monitoring device according to the present invention. Membrane 75 includes speaker grill 77, microphone grill 79, communication status LEDs 43, push-to-talk button 45, on/off buttons 67, and power status LEDs 69. Membrane 75 is mounted on enclosure top 81. Ethernet connector 48 and power jack 85 are visible on the side of the device. Rubber buffers 83 are mounted on the corners of enclosure top 81. Nodes 61 and 63 are mounted on the sides of enclosure base 87 while base buffers 93 are mounted on the corners of enclosure base 87.

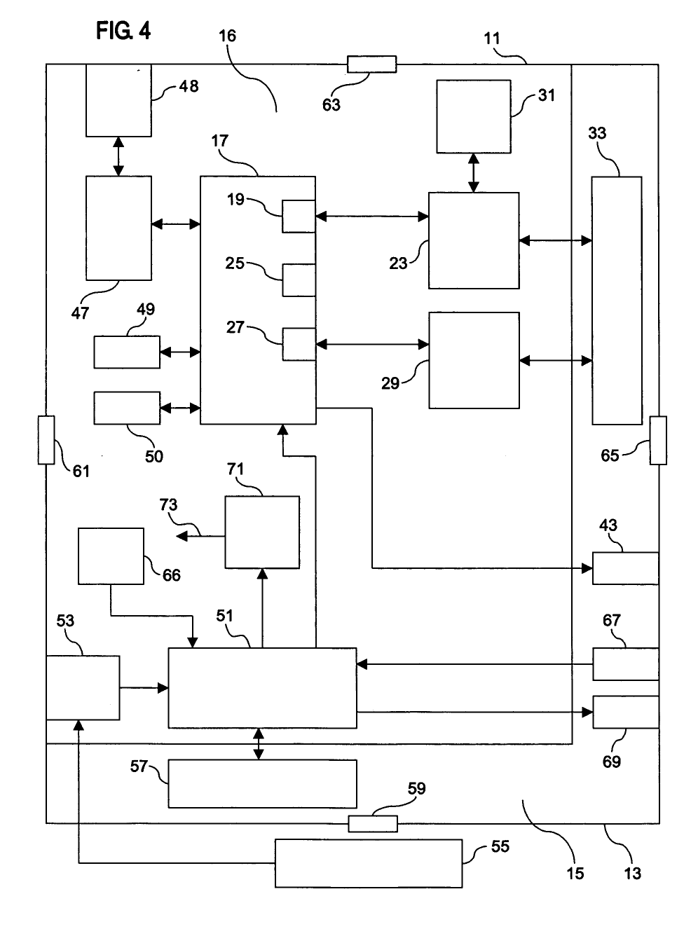

FIG. 4 is a block diagram of an electronic tracking and monitoring device according to the present invention. The tracking device includes single board computer 11, enclosure 13, and space 15 between single board computer 11 and enclosure 13. Single board computer 11 includes circuit board 16 upon which many of the components of the tracking device are mounted. Although a single board computer is preferred for reasons including size and cost, those of skill in the art will recognize that embodiments of the device could be constructed by other, less preferable, methods. In a preferred embodiment, circuit board 16 is an eight-layer impedance controlled printed circuit board manufactured from FR4 material with components mounted on both sides. Processor 17 is mounted on circuit board 16. In a preferred embodiment, a model PXA255 RISC processor, available from Intel Corporation, is used; however, those of skill in the art will recognize that many processors may be used with the invention.

Processor 17 includes communications port one 19 (COM1). COM1 communicates with communication component 23. In a preferred embodiment, communication component 23 is a wireless modem, and specifically a model GR47 global system for mobile communications (GSM® from GSM MOU Association Corporation) modem or a model GR48 GSM® modem, both available from Sony Ericsson Mobile Communications AB. The GR47 GSM® modem operates in the 900 MHz and 1800 MHz GSM® bands. The GR48 modem operates in the 850 MHz and 1900 MHz GSM® bands. Those of skill in the art will recognize that communication component 23 could comprise a wide variety of wireless communication means including, for example: any of a variety of cellular modems, a Wi-Fi card, a WiMAX card, or a satellite modem. Communication component 23 communicates with a wireless network using a transmission protocol. In a preferred embodiment, TCP/IP is used, and the device is preferably assigned an IP address. Alternatively, UDP or other protocols could be used.

Processor 17 also includes communications port two 25 (COM2), which is not in use; however, COM2 could be used during development by connecting a pin-header. Such an arrangement would provide a software console port suitable for downloading a new operating system image and/or application software. Processor 17 also includes communications port three 27 (COM3). COM3 communicates with location component 29. In a preferred embodiment, location component 29 is a GPS receiver, and specifically a model iTRAX03 GPS receiver available from Fastrax, Ltd. of Finland. Those of skill in the art will recognize that location component 29 could comprise a wide variety of location means including, for example, a LORAN receiver or dead reckoning device. Location component 29 preferably provides real time location data. That data is transferred via communication component 23 to a network.

In a preferred embodiment, communication component 23 communicates with SIM socket 31. Communication component 23 and location component 29 preferably communicate with antenna 33. Antenna 33 is located in space 15 and functions as the antenna for both communication component 23 and location component 29. In a preferred embodiment, antenna 33 is a triple band antenna. In one preferred embodiment, antenna 33 provides coverage for 900 MHz (880.2-914.8 MHz transmitting; 925.2-959.8 MHz receiving), 1800 MHz (1710.2-1784.8 MHz transmitting; 1805.2-1879.8 MHz receiving), and 1573.42-1577.42 MHz bands. In another preferred embodiment, antenna 33 provides coverage for 850 MHz (848.8 MHz transmitting; 869.2-893.8 MHz receiving), 1900 MHz (1850.2-1909.8 MHz transmitting; 1930.2-1989.8 MHz receiving), and 1573.42-1577.42 MHz bands. In the illustrated embodiment, antenna 33 is located in space 15; however, antenna 33 also could be located external to enclosure 13.

Processor 17 provides digital I/O to control of communication status LEDs 43 as well as power sequencing of communication component 23. Processor 17 also communicates with Ethernet controller 47, which in turn communicates with Ethernet connection 48. In a preferred embodiment, Ethernet controller 47 provides a single 10BaseT interface and Ethernet connection 48 consists of an RJ45 connection compatible with a standard Ethernet adaptor cable. Ethernet compatibility permits the device to interoperate with a wide variety of devices. For instance, the device may be connected to a computer for operation using a wired connection. Additionally, the device may be connected to any sensor or system providing an electronic signal. For example, the device could receive engine temperature data from a temperature sensor and provide real time temperature data. If the temperature exceeded a range of acceptable temperatures, the device could signal monitoring personnel. Those of skill in the art will understand that other wired electronic connections such as FireWire® and USB, as well as short range wireless connections such as IrDA® and Bluetooth®, are within the scope of the invention and can be used to connect with many sensors or systems providing an electronic signal.

Processor 17 further communicates with nonvolatile memory 49. In a preferred embodiment, nonvolatile memory 49 comprises a 16 MB flash memory. Nonvolatile memory 49 preferably stores boot software, open source operating system software having networking functionality, and application platform software providing a runtime environment. In a preferred embodiment, the boot software consists of REDBOOT® to boot embedded LINUX®, the operating system consists of embedded LINUX®, and the application platform consists of IBM® J2ME JAVA® run-time environment and application software. The LINUX® operating system is preferred because it is open source, supports networking functions such as TCP/IP and UDP, and supports JAVA. Those of skill in the art will recognize that the type of nonvolatile memory and stored software disclosed are only examples, and that many types of nonvolatile memory and software are operable with the invention. Single board computer 11 preferably includes over-the-air programming functionality. Thus, with this feature, software can be uploaded or updated remotely while the device is in use. This feature preferably permits new software to be transferred over a network and loaded into nonvolatile memory 49.

Processor 17 also communicates with system memory 50. In a preferred embodiment, system memory 50 comprises a 32 MB SDRAM.

Single board computer 11 also includes power source management circuits 51. Circuits 51 may receive power from power connector 53. Power connector 53 is preferably adapted to accept power from vehicle battery 55 or an external 12V DC supply via a power jack. Power connector 53 preferably includes power conditioning circuits that provide transient voltage protection and constant 12V power to power source management circuits 51. Circuits 51 also may receive power from battery 57. In a preferred embodiment, battery 57 is a rechargeable 4.8V NiMH battery pack comprising four AA size 1.8 Ah cylindrical cells located within space 15. Those of skill in the art will recognize that many types, sizes, and capacities of batteries are operable with the invention, such as lithium ion batteries. Circuits 51 also may receive power from nodes 59, 61, 63, and 65 via diode bridge 66. The nodes preferably receive 12V power when the device is placed inside a charger. The charger includes contacts adapted to be positioned adjacent to the nodes in a plurality of orientations, such as right-side-up, up-side-down, side-ways, and backward. In a preferred embodiment, any opposite pair of nodes can provide power to the device, without regard to the polarity of the voltage applied, as long as one node receives voltage of positive polarity and the other node receives voltage of negative polarity. For example, node 59 could receive voltage of positive polarity and node 63 could receive voltage of negative polarity, or node 59 could receive voltage of negative polarity and node 63 could receive voltage of positive polarity. Power from the nodes passes through diode bridge 66, which ensures the correct polarity, and from there feeds into power source management circuits 51.

Power source management circuits 51 control power source selection, battery 57 charging, and device on/off status. When receiving power from a power jack input or vehicle battery 55, circuits 51 preferably use that power source to power the device and charge battery 57. Circuits 51 preferably stop charging battery 57 if circuits 51 detect that that battery 57 is fully charged. When receiving power from nodes 59, 61, 63, and 65, circuits 51 preferably signal processor 17 to cut power to communication component 23. Circuits 51 preferably charge battery 57 until fully charged while receiving power from the nodes. When power to the nodes is removed processor 17 preferably boots up. Power to communication component 23 is preferably restored when the device is signaled to do so by the charger. When receiving power from battery 57, circuits 51 preferably monitor battery 57 for sufficient power. In the preferred embodiment, circuits 51 signal processor 17 if the voltage provided by battery 57 drops below a predetermined level. Circuits 51 preferably cut-off battery 57 if the voltage provided by battery 57 drops below a lower predetermined voltage such that over-discharge of battery 57 is prevented.

Power source management circuits 51 communicate with on/off buttons 67. On/off buttons 67 preferably may be remotely disabled using software in order to prevent a user from turning off the device. Circuits 51 also communicate with power status LEDs 69. Circuits 51 further communicate with power supply units 71. In a preferred embodiment, power supply units 71 provide power 73 to single board computer 11, including a 1.0V supply to processor 17, a 3.3V supply to power much of single board computer 11, a 3.6V supply to communication component 23, and a 2.8V supply to location component 29.

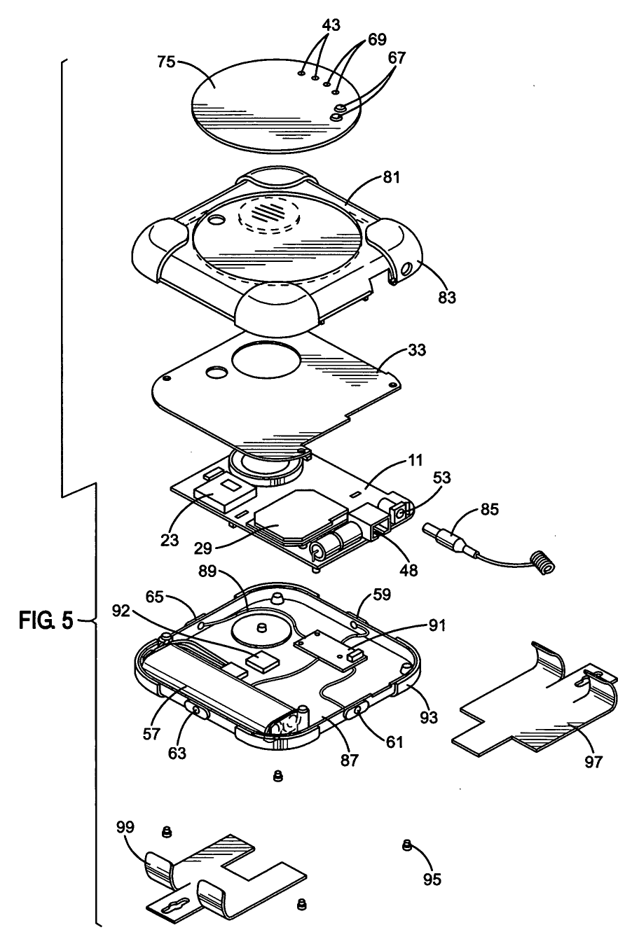

FIG. 5 is an exploded view of an electronic tracking and monitoring device according to the present invention. Membrane 75 includes communication status LEDs 43, on/off buttons 67, and power status LEDs 69. Membrane 75 is mounted on enclosure top 81. Enclosure top 81 is preferably molded from either polypropylene or polycarbonate plastic. Rubber buffers 83 are mounted on the corners of enclosure top 81. Antenna 33 is mounted below enclosure top 81 but above single board computer 11 in order to maximize signal strength. Single board computer 11 includes communication component 23, location component 29, Ethernet connector 48, and power connector 53. Power connector 53 is adapted to accept power jack 85.

Enclosure base 87 is preferably molded from either polypropylene or polycarbonate plastic. Enclosure base 87 supports battery 57 and single board computer 11. Nodes 59, 61, 63 and 65 are mounted on the sides of enclosure base 87. The nodes are connected by wires 89 to node base 91, which in turn is connected to single board computer 11. RFID label 92 is preferably mounted on enclosure base 87 to permit identification of the device, and is readable from at least the underside of the device when assembled. Base buffers 93 are mounted on the corners of enclosure base 87. Screw-hole plugs 95 are preferably fitted to base 87 after assembly of the device. Bulkhead mounting brackets 97 and 99 are provided for permanent or semi-permanent installation of the device in a vehicle or other asset where installation is desired.

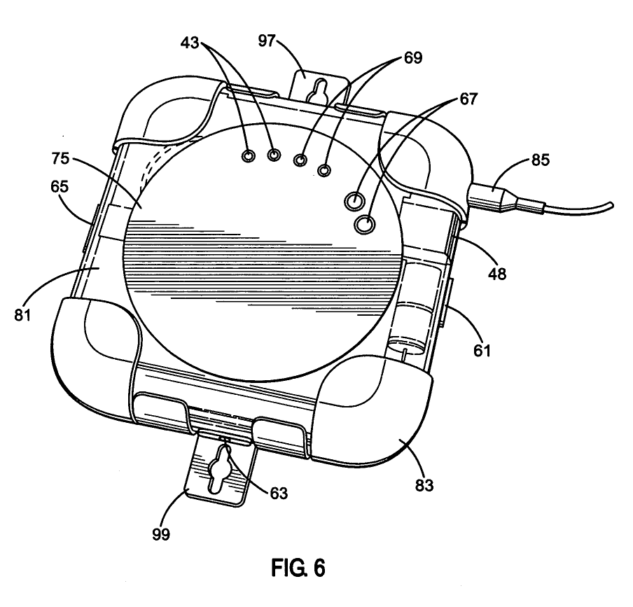

FIG. 6 is a perspective view of the exterior of an electronic tracking and monitoring device according to the present invention. Membrane 75 includes communication status LEDs 43, on/off buttons 67, and power status LEDs 69. Membrane 75 is mounted on enclosure top 81. Ethernet connector 48 and charging jack 85 are visible on the side of the device. Rubber buffers 83 are mounted on the corners of enclosure top 81. Nodes 61, 63, and 65 are mounted on the sides of enclosure base 87. Bulkhead mounting brackets 97 and 99 mount securely to the device and provide for permanent or semi-permanent installation of the device.

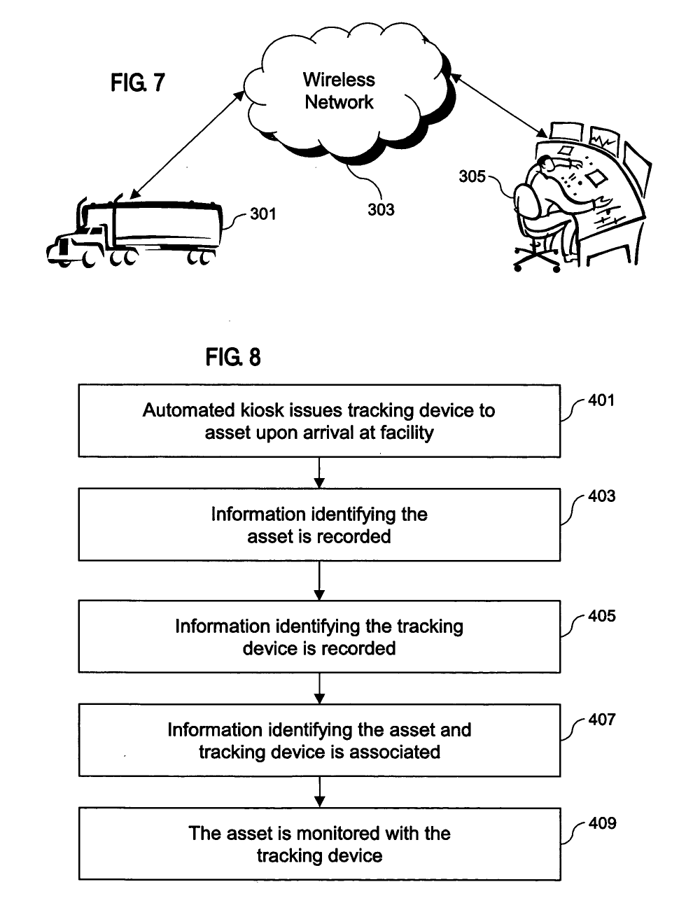

FIG. 7 is a diagram of a system for tracking and monitoring assets. Asset 301 has onboard a single board computer in communication with wireless network 303. The single board computer includes a location component and a communication component. Those of skill in the art will recognize that the location component could comprise a wide variety of location means including, for example, a GPS receiver, LORAN receiver, or dead reckoning device. The location component preferably provides real time location data. Those of skill in the art will understand that the communication component could comprise a wide variety of wireless communication means including, for example, any of a variety of cellular modems, a Wi-Fi card, a WiMAX card, or a satellite modem. Wireless network 303 could comprise, for example, a cellular network, a Wi-Fi network, a WiMAX network, or a satellite network.

The single board computer is capable of determining or acquiring a wide variety of data using an electronic data connection. Those of skill in the art will understand that many electronic connections, such as Ethernet, FireWire®, USB, IrDA®, and Bluetooth®, are within the scope of the invention and can be used to connect with many sensors or systems providing an electronic signal. An electronic data connection permits the device to interoperate with a wide variety of other devices. For instance, the device may be connected to a computer for operation using a wired or short range wireless connection. Additionally, the device may be connected to any sensor or system providing an electronic signal. For example, the device could receive engine temperature data from a temperature sensor and provide real time temperature data. If the temperature exceeded a range of acceptable temperatures, the device could signal monitoring personnel.

Location or other data are transferred via the communication component to wireless network 303. Using the communication component, the single board computer communicates with wireless network 303 using a transmission protocol. In a preferred embodiment, TCP/IP is used, and the single board computer is preferably assigned an IP address. Alternatively, UDP or other protocols could be used.

The single board computer also comprises a nonvolatile memory. The nonvolatile memory preferably stores boot software, open source operating system software having networking functionality, and application platform software providing a runtime environment. In a preferred embodiment, the boot software consists of REDBOOT® to boot embedded LINUX®, the operating system consists of embedded LINUX®, and the application platform consists of IBM® J2ME JAVA® run-time environment and application software available from International Business Machines Corporation. The LINUX® operating system is preferred because it is open source, supports networking functions such as TCP/IP and UDP, and supports JAVA®. Those of skill in the art will recognize that many types of nonvolatile memory and software are operable with the invention. The single board computer preferably includes over-the-air programming functionality. With this feature, software can be uploaded or updated remotely while the device is in use.

A monitoring center 305 is also in communication with wireless network 303, and in this way communicates with the single board computer onboard asset 301. Monitoring center 305 receives real time location data and/or other useful data. For example, location data can be used for geo-fencing. In this application, personnel at the monitoring center are alerted if asset 301 leaves the geographic area in which it is permitted to operate. Personnel might establish verbal contact with the operator of asset 301 using a push-to-talk feature or deploy security personal. Monitoring center 305 is also able to remotely program the single board computer using over-the-are programming. Monitoring center 305 can take many forms. In one embodiment, monitoring center 305 is a fully staffed control center; however, because communication with asset 301 is wireless, monitoring center 305 can also take the form of, for example, a laptop computer or PDA.

FIG. 8 is a flow chart of a method of securing a facility. An automated kiosk issues a tracking device to an asset upon arrival at the facility 401. In a preferred embodiment, the kiosk also acts as a charger for the tracking devices. The tracking device is then linked to the asset 403, 405, 407. Information identifying the asset is recorded 403. For example, if the asset is a vehicle, the vehicle's license plate number might be recorded. If the asset is a person, the person's driver's license number or fingerprint might be recorded. Multiple forms of identifying information are preferably recorded if available. Information identifying the tracking device is also recorded 405. Those of skill in the art will understand that steps 403 and 405 can occur in any order or simultaneously. The information identifying the tracking device might take the form of information stored in a bar code or an RFID tag. In a preferred embodiment, the automated kiosk reads an RFID tag that is part of the tracking device when the tracking device is dispensed. The information identifying the asset and tracking device are then associated 407. In a preferred embodiment, the association step occurs by transmission of the identifying information collected in steps 403 and 405 to a computer that records the information such that the information is linked. The asset is then monitored with the tracking device 409. In a preferred embodiment, the monitoring is facilitated by a network in communication with the tracking device.

In the drawings and specification, there have been disclosed embodiments of the invention and, although specific terms are employed, they are used in a generic and descriptive sense only and not for the purpose of limitation, the scope of the invention being set forth in the following claims.

What claimed is:

1. An electronic device for tracking assets comprising:
a single board computer adapted to communicate with a network, the computer comprising:
a location component; and
a communication component.

2. The electronic device of claim 1 wherein the location component and the communication component are part of a single module.

3. The electronic device of claim 1 wherein the single board computer further comprises a nonvolatile memory.

4. The electronic device of claim 1 wherein the single board computer further comprises an open source operating system software having networking functionality.

5. The electronic device of claim 1 wherein the single board computer further comprises an application platform software providing a runtime environment.

6. The electronic device of claim 1 wherein the location component includes a global positioning system receiver.

7. The electronic device of claim 1 wherein the communication component includes a wireless modem.

8. The electronic device of claim 7 wherein the wireless modem includes an integrated digital enhanced network modem.

9. The electronic device of claim 8 wherein the electronic device has push-to-talk functionality.

10. The electronic device of claim 9 wherein the integrated digital enhanced network modem multiplexes push-to-talk and data transfer.

11. The electronic device of claim 7 wherein the wireless modem includes a global system for mobile communications modem.

12. The electronic device of claim 1 further comprising an antenna.

13. The electronic device of claim 1 wherein the single board computer has over-the-air programming functionality.

14. The electronic device of claim 1 further comprising a durable enclosure.

15. The electronic device of claim 1 further comprising a radio frequency identification tag.

16. A system for tracking assets comprising:
a network; and
a single board computer in communication with the network, the computer comprising:
a location component; and
a communication component.

17. The system of claim 16 wherein the location component and the communication component are part of a single module.

18. The system of claim 16 wherein the single board computer further comprises a nonvolatile memory.

19. The system of claim 16 wherein the single board computer further comprises an open source operating system software having networking functionality.

20. The system of claim 16 wherein the single board computer further comprises an application platform software providing a runtime environment.

21. The system of claim 16 wherein the location component includes a global positioning system receiver.

22. The system of claim 16 wherein the communication component includes a wireless modem.

23. The system of claim 22 wherein the wireless modem includes an integrated digital enhanced network modem.

24. The system of claim 23 wherein the electronic device has push-to-talk functionality.

25. The system of claim 24 wherein the integrated digital enhanced network modem multiplexes push-to-talk and data transfer.

26. The system of claim 23 wherein the network includes an integrated digital enhanced network.

27. The system of claim 22 wherein the wireless modem includes a global system for mobile communications modem.

28. The system of claim 27 wherein the network includes a global system for mobile communications network.

29. The system of claim 16 further comprising an antenna.

30. The system of claim 16 wherein the network assigns the electronic device an Internet protocol address.

31. The system of claim 16 wherein the single board computer communicates with the network via transmission control protocol with Internet protocol.

32. The system of claim 16 wherein the single board computer has over-the-air programming functionality.

33. The system of claim 16 further comprising a durable enclosure.

34. The system of claim 16 further comprising a radio frequency identification tag.

35. An electronic device for tracking assets comprising:
a computer, the computer comprising:
a location component; and
an integrated digital enhanced network modem.

36. The electronic device of claim 35 wherein the location component and the integrated digital enhanced network modem are part of a single module.

37. The electronic device of claim 35 wherein the computer further comprises a nonvolatile memory.

38. The electronic device of claim 35 wherein the computer further comprises an open source operating system software having networking functionality.

39. The electronic device of claim 35 wherein the computer further comprises an application platform software providing a runtime environment.

40. The electronic device of claim 35 wherein the location component includes a global positioning system receiver.

41. The electronic device of claim 35 wherein the computer has over-the-air programming functionality.

42. The electronic device of claim 35 wherein the computer has push-to-talk functionality.

43. The electronic device of claim 42 wherein the integrated digital enhanced network modem multiplexes push-to-talk and data transfer.

44. The electronic device of claim 35 further comprising an antenna.

45. The electronic device of claim 35 wherein the device has stack charging capability in a plurality of orientations.

46. The electronic device of claim 35 further comprising a durable enclosure.

47. The electronic device of claim 35 further comprising a radio frequency identification tag.

48. An electronic device for tracking assets comprising:
a computer having over-the-air programming functionality, the computer comprising:
a location component; and
a communication component.

49. The electronic device of claim 48 wherein the location component and the communication component are part of a single module.

50. The electronic device of claim 48 wherein the computer further comprises a nonvolatile memory.

51. The electronic device of claim 48 wherein the computer further comprises an open source operating system software having networking functionality.

52. The electronic device of claim 48 wherein the computer further comprises an application platform software providing a runtime environment.

53. The electronic device of claim 48 wherein the location component includes a global positioning system receiver.

54. The electronic device of claim 48 wherein the device has stack charging capability in a plurality of orientations.

55. The electronic device of claim 48 wherein the electronic device has push-to-talk functionality.

56. The electronic device of claim 55 wherein the communication component includes an integrated digital enhanced network modem.

57. The electronic device of claim 56 wherein the integrated digital enhanced network modem multiplexes push-to-talk and data transfer.

58. The electronic device of claim 48 wherein the communication component includes a global system for mobile communications modem.

59. The electronic device of claim 48 further comprising an antenna.

60. The electronic device of claim 48 further comprising a durable enclosure.

61. The electronic device of claim 48 further comprising a radio frequency identification tag.

62. A system for stack charging an electronic device in a plurality of orientations comprising:
a charger having a plurality contacts; and
an electronic device having a plurality of nodes, the nodes arranged so that at least one node is adjacent to at least one positive contact and at least one different node is adjacent to at least one negative contact in each orientation.

63. The system of claim 62 wherein the plurality of nodes includes a first node arranged opposite from a second node and a third node arranged opposite from a fourth node.

64. The system of claim 62 wherein the electronic device includes a diode bridge for ensuring the correct polarity of a voltage.

65. A method of securing a facility comprising the steps of:
issuing a tracking device to an asset by an automated kiosk upon arrival at the facility;
linking the tracking device to the asset; and
monitoring the asset with the tracking device.

66. The method of claim 65 wherein the automated kiosk includes a charger.

67. The method of claim 65 wherein the linking step comprises the steps of:
recording information identifying the asset;
recording information identifying the tracking device; and
associating the information identifying the asset with the information identifying the tracking device.

68. The method of claim 67 wherein the information identifying the tracking device is stored in a radio frequency identification tag that is part of the tracking device.

69. The method of claim 65 wherein the monitoring is facilitated by a network in communication with the tracking device.
